(19) United States
(12) Patent Application Publication
(10) Pub. No.: US 2026/0285321 A1
(43) Pub. Date: Sep. 24, 2026

(54) APPARATUS AND METHOD FOR SUPPORTING OFF-ROAD DRIVING AND VEHICLE AND STORAGE MEDIUM INCLUDING THE SAME

(71) Applicants: Hyundai Motor Company, Seoul (KR); Kia Corporation, Seoul (KR)

(72) Inventors: Jun Han KANG, Hwaseong-si (KR); Young Il KIM, Hwaseong-si (KR); Da Hoon JEONG, Hwaseong-si (KR); Ji Hun BYUN, Hwaseong-si (KR); Ik Jin UM, Hwaseong-si (KR); In Ho OH, Hwaseong-si (KR)

(73) Assignees: Hyundai Motor Company, Seoul (KR); Kia Corporation, Seoul (KR)

(21) Appl. No.: 19/298,501

(22) Filed: Aug. 13, 2025

(30) Foreign Application Priority Data
Mar. 24, 2025 (KR) 10-2025-0037162

(51) Int. Cl. B60W 30/18; B60W 10/08; B60W 30/182

(52) U.S. Cl. CPC B60W 30/18172; B60W 10/08; B60W 30/182; B60W 2300/185; B60W 2520/105; B60W 2520/125; B60W 2520/14; B60W 2520/26; B60W 2520/30; B60W 2540/10; B60W 2540/18; B60W 2552/05; B60W 2720/403

(57) ABSTRACT

An apparatus for supporting an off-road driving includes a controller configured to receive off-road driving data of a vehicle capable of an all-wheel drive (AWD) and control AWD flexibility of the vehicle according to AWD flexibility control data by applying the off-road driving data to AWD flexibility logic, wherein the AWD flexibility logic is configured to vary the AWD flexibility according to a possibility of vehicle stuck in off-road terrain based on the off-road driving data.

### CROSS-REFERENCE TO RELATED APPLICATION(S)

This application claims benefit of priority to Korean Patent Application No. 10-2025-0037162 filed on Mar. 24, 2025 in the Korean Intellectual Property Office, the disclosure of which is incorporated herein by reference in its entirety.

### BACKGROUND

### 1. Field The present disclosure relates to an apparatus and method for supporting off-road driving and a vehicle and storage medium including the same.

### 2. Description of Related Art

The number of people who enjoy camping using vehicles and the number of people who enjoy off-road driving sports have continuously increased. Accordingly, a technology allowing comfortable and safe driving on unpaved off-road terrains other than general paved roads has been required, and thus, various vehicle driving control modes helping to control the driving of vehicles specialized for off-road applications have been developed.

When driving off-road, it is important to drive so that vehicles do not get stuck. Here, a stuck vehicle refers to a vehicle in a state in which the vehicle is stuck in the road surface and cannot move. If a vehicle gets stuck, not only will the vehicle not be able to move, but it may also be very difficult to move the vehicle that has been stuck once again. In particular, in the case of inexperienced drivers, as they try to control the vehicle more strongly to escape from the stuck state, the vehicle may become more stuck, and the stuck vehicle may eventually be freed from the stuck state only by using external force, such as that of a tow truck.

Therefore, when a vehicle is driven off-road, such as on an unpaved road, it is important that the vehicle does not get stuck, that is, unable to move in the road surface.

### SUMMARY

An aspect of the present disclosure is to provide an apparatus and method for supporting off-road driving and a vehicle and storage medium including the same, capable of efficiently improving the overall optimality of at least one of the performance, fuel efficiency, and/or stability of the vehicle, while effectively reducing the overall final possibility of vehicle stuck in off-road terrain even if road surface severity of the off-road terrain varies.

According to an aspect of the present disclosure, an apparatus for supporting an off-road driving includes: a controller configured to receive off-road driving data of a vehicle capable of an all-wheel drive (AWD) and control AWD flexibility of the vehicle according to AWD flexibility control data by applying the off-road driving data to AWD flexibility logic, wherein the AWD flexibility logic is configured to vary the AWD flexibility according to a possibility of vehicle stuck in off-road terrain based on the off-road driving data.

The AWD flexibility logic may be configured such that the controller further reduces or eliminates a front and rear wheel torque distribution change range of the vehicle when the possibility of vehicle stuck is higher than an AWD flexibility change criterion, compared to when the possibility of vehicle stuck is lower than the AWD flexibility change criterion.

The AWD flexibility change criterion may include a first AWD flexibility change criterion and a second AWD flexibility change criterion higher than the first AWD flexibility change criterion, and the AWD flexibility logic may be configured such that, when the possibility of vehicle stuck is higher than the second AWD flexibility change criterion, the controller fixes the front and rear wheel torque distribution of the vehicle to a predetermined distribution ratio, and when the possibility of vehicle stuck is higher than the first AWD flexibility change criterion, compared to when the possibility of vehicle stuck is lower than the first AWD flexibility change criterion, the controller further reduces the front and rear wheel torque distribution change range of the vehicle.

The controller may reduce a minimum torque value of front and rear wheels of the vehicle when the vehicle is in a turning state or the vehicle stability is below a stability reference, as the AWD flexibility is higher.

The controller may concentrate more torque on the front wheel when the vehicle is in an oversteer state, as the AWD flexibility is higher, and concentrate more torque on the rear wheel when the vehicle is in an understeer state, as the AWD flexibility is higher.

The controller may configure off-road type data of the vehicle, the off-road type data may include at least two of snow type data corresponding to a snowy road, sand type data corresponding to a sandy road, and mud type data corresponding to a muddy road, and the AWD flexibility logic may be configured to determine the AWD flexibility change criterion according to the off-road type data of the vehicle.

The controller may configure driving mode data for selecting one of a plurality of driving modes corresponding to different driving performances of the vehicle, and the AWD flexibility logic may be configured such that the AWD flexibility change criterion is determined according to the driving mode data of the vehicle.

The controller may determine whether a vehicle stability control logic is to intervene according to the AWD flexibility, and when the vehicle stability control logic intervenes, the controller may generate front wheel torque control data and rear wheel torque control data determined to improve vehicle stability by applying the off-road driving data to the vehicle stability control logic.

The controller may receive the off-road driving data from a sensor unit, and the off-road driving data may include at least one of a speed of the vehicle, acceleration of the vehicle, a yaw rate of the vehicle, a yaw acceleration of the vehicle, a steering angle of the vehicle, a number of rotations of a wheel of the vehicle, a torque of the vehicle, and an acceleration input value of the vehicle.

The AWD flexibility logic may be configured to periodically determine the AWD flexibility at every predetermined determination period, and the determination period may be less than 10 seconds.

The AWD flexibility logic may be configured to selectively control the AWD flexibility depending on whether the off-road driving mode is used, and the controller may determine whether to use the off-road driving mode, either manually according to an input or automatically based on the off-road driving data.

According to another aspect of the present disclosure, a method for supporting off-road driving includes: storing AWD flexibility logic of a vehicle based on a possibility of vehicle stuck of a vehicle capable of all-wheel drive (AWD) on an off-road; receiving off-road driving data of the vehicle; and controlling AWD flexibility of the vehicle by applying the off-road driving data to the AWD flexibility logic.

The AWD flexibility logic may be configured to further reduce or eliminate a front and rear wheel torque distribution change range of the vehicle as the possibility of vehicle stuck increases.

The AWD flexibility logic may be configured to determine the AWD flexibility according to off-road type data of the vehicle and the possibility of vehicle stuck, and the off-road type data may include at least two of snow type data corresponding to a snowy road, sand type data corresponding to a sandy road, and mud type data corresponding to a muddy road.

The method may further include: selectively determining whether the vehicle stability control logic is to intervene or an intervention level of the vehicle stability control logic according to the AWD flexibility, depending on whether the vehicle is in a turning state or vehicle stability is below a stability reference; and generating front wheel torque control data and rear wheel torque control data determined to improve vehicle stability by applying the off-road driving data to the vehicle stability control logic when the vehicle stability control logic intervenes.

According to another aspect of the present disclosure, there is provided a non-transitory storage medium having recorded thereon one or more programs including instructions for executing the method for supporting off-road driving.

According to another aspect of the present disclosure, a vehicle includes: a controller including a processor and a non-transitory storage medium having recorded thereon one or more programs configured to be executable by the processor, wherein the one or more programs include instructions for executing the method for supporting off-road driving.

According to another aspect of the present disclosure, a vehicle includes: a first motor providing torque to a front wheel; a second motor providing torque to a rear wheel; a sensor unit sensing off-road driving data; and a controller configured to control the first motor and the second motor to enable all-wheel drive (AWD) and control AWD flexibility according to AWD flexibility control data by applying the off-road driving data to an AWD flexibility logic, wherein the AWD flexibility logic is configured to vary the AWD flexibility according to the possibility of the vehicle stuck in off-road terrain based on the off-road driving data.

The AWD flexibility logic may be configured such that the controller further reduces or eliminates a front and rear wheel torque distribution change range of the vehicle when the possibility of vehicle stuck is higher than an AWD flexibility change criterion, compared to when the possibility of vehicle stuck is lower than the AWD flexibility change criterion, the AWD flexibility logic may be configured such that the AWD flexibility change criterion is determined according to off-road type data, and the off-road type data may include at least two of snow type data corresponding to a snowy road, sand type data corresponding to a sandy road, and mud type data corresponding to a muddy road.

The controller may reduce a minimum torque value f the front and rear wheels when the vehicle is in a turning state or vehicle stability is below a stability reference as the AWD flexibility increases.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are diagrams illustrating an apparatus for supporting off-road driving and a vehicle according to an embodiment of the present disclosure;

FIG. 3 is a block diagram specifically illustrating a controller and a sensor unit of an apparatus and method for supporting off-road driving and a vehicle and a storage medium according to an embodiment of the present disclosure;

FIG. 4 is a diagram illustrating AWD flexibility control according to the possibility of vehicle stuck of an apparatus and method for supporting off-road driving and a vehicle and a storage medium according to an embodiment of the present disclosure;

FIG. 5 is a flowchart illustrating a method for supporting off-road driving according to an embodiment of the present disclosure;

FIG. 6 is a flowchart illustrating an operation of an apparatus and method for supporting off-road driving and a vehicle and a storage medium based on a AWD flexibility change criterion according to an embodiment of the present disclosure;

FIG. 7 is a flowchart illustrating an operation in which a AWD flexibility change criterion of an apparatus and method for supporting off-road driving and a vehicle and a storage medium is determined according to operation mode data and/or off-road type data according to an embodiment of the present disclosure;

FIG. 8 is a graph illustrating an operation in which a AWD flexibility change criterion of an apparatus and method for supporting off-road driving and a vehicle and a storage medium is determined according to off-road type data according to an embodiment of the present disclosure;

FIGS. 9 and 10 are diagrams illustrating a plurality of AWD flexibility change criterion sets of an apparatus and method for supporting off-road driving and a vehicle and a storage medium according to an embodiment of the present disclosure;

FIG. 11 is a flowchart illustrating an operation of an apparatus and method for supporting off-road driving and a vehicle and a storage medium based on first and second AWD flexibility change criterion according to an embodiment of the present disclosure;

FIG. 12 is a diagram illustrating a difference in the range of change in front and rear wheel torque distribution according to AWD flexibility in a turning state of an apparatus and method for supporting off-road driving and a vehicle and a storage medium according to an embodiment of the present disclosure; and

FIG. 13 is a flowchart illustrating determining whether a vehicle stability control logic is to intervene and/or an intervention level thereof according to AWD flexibility of an apparatus and method for supporting off-road driving and a vehicle and a storage medium according to an embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In this specification, vehicles refer to a variety of vehicles that move transported objects, such as people, animals, or goods, from a starting point to a destination. These vehicles are not limited to vehicles that run on roads or tracks.

Hereinafter, embodiments of the present disclosure will be described with reference to the accompanying drawings.

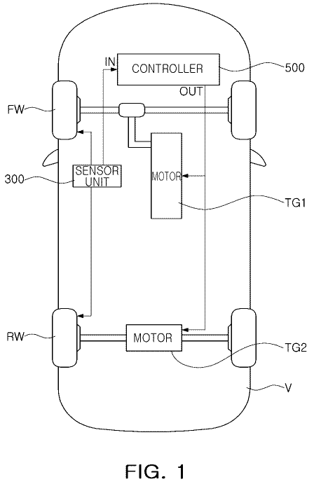

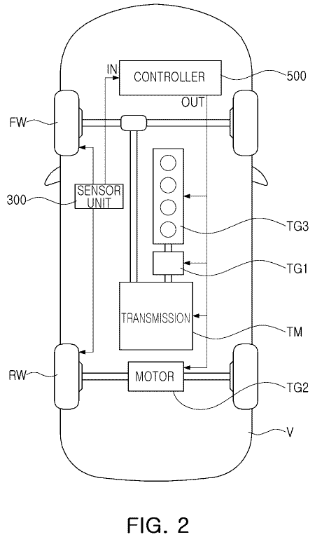

Referring to FIGS. 1 and 2, a vehicle V may include a first motor TG1 providing torque to a front wheel FW and a second motor TG2 providing torque to a rear wheel RW and may be capable of all-wheel drive (AWD). AWD may be a driving method that may freely determine the torque of the front wheel FW and the torque of the rear wheel RW, and may be a driving method that may flexibly determine a torque distribution ratio of the front wheel FW and the rear wheel RW.

Referring to FIG. 1, the vehicle V may include an electric vehicle not including an engine. Referring to FIG. 2, the vehicle V may include a hybrid electric vehicle (including a plug-in hybrid electric vehicle) including an engine TG3 and a transmission TM. The configuration (e.g., number, position, connection relationship, etc.) of the first and second motors TG1 and TG2 is not limited. For example, at least one of the first and second motors TG1 and TG2 may include a converter (e.g., an inverter) for converting between direct current and alternating current and may include a battery (e.g., a high-voltage battery pack) storing energy and being rechargeable.

Referring to FIGS. 1, 2, and 3, the vehicle V according to an embodiment of the present disclosure may include a sensor unit 300 and a controller 500. For example, the controller 500 may include a vehicle control unit (VCU) and/or a microcontroller unit (MCU).

The sensor unit 300 may sense (e.g., monitor, constantly sense) off-road driving data. For example, the off-road driving data may include at least one of a speed of the vehicle V (a sensing value of a vehicle speed sensor 302 of the sensor unit 300), an acceleration of the vehicle V (a sensing value of an acceleration sensor 305 of the sensor unit 300), a yaw rate of the vehicle V (a sensing value of a yaw rate sensor 301 of the sensor unit 300), a yaw acceleration of the vehicle V (a sensing value of the yaw acceleration sensor 304 of the sensor unit 300), a steering angle of the vehicle V (a sensing value of a steering angle sensor 307 of the sensor unit 300), an RPM of the wheels (the front wheel FW and/or the rear wheel RW) of the vehicle V (a sensing value of a wheel speed sensor 303 of the sensor unit 300), a torque of the vehicle V (a sensing value of a torque sensor 306 of the sensor unit 300), and an acceleration input value of the vehicle V (a sensing value of an APS sensor 308 of the sensor unit 300). The sensor unit 300 may include at least one of the vehicle speed sensor 302, the acceleration sensor 305, the yaw rate sensor 301, the yaw acceleration sensor 304, the steering angle sensor 307, the wheel speed sensor 303, the torque sensor 306, and the APS sensor 308.

The torque of the vehicle V may include a torque of the engine (or motor) and/or a torque of the wheels (the front wheel FW and/or the rear wheel RW). The acceleration of the vehicle V may include a longitudinal acceleration of the vehicle V and/or a lateral acceleration of the vehicle V. The yaw rate is a speed at which the posture of the vehicle V rotates in the yaw direction, and the yaw direction is a direction in which the vehicle V faces the ground (e.g., the direction of gravity). The APS of the APS sensor 308 may be an accelerator pedal sensor.

The controller 500 may receive (IN) the off-road driving data from the sensor unit 300 and control the AWD based on the off-road driving data, thereby controlling the torque of the first and second motors TG1 and TG2.

For example, in order to control the AWD, the controller 500 may store in advance a vehicle stability control logic (e.g., turning control logic, traction control system (TCS), electronic stability program (ESP), etc.) or a performance-fuel efficiency optimization control logic, may independently determine the torque of the first motor TG1 and the torque of the second motor TG2 in real time according to the vehicle stability control logic and/or the performance-fuel efficiency optimization control logic, and may flexibly control the first and second motors TG1 and TG2 according to the determined torque. Accordingly, the overall optimality of at least one of the performance, fuel efficiency, and stability of the vehicle V may be improved.

For example, by controlling the AWD, the controller 500 may control a front and rear wheel torque distribution ratio by determining the torque distribution ratio of the first and second motors TG1 and TG2. The controller 500 may change the front and rear wheel torque distribution ratio (which may be accompanied by a change in the total torque) by reducing or increasing the torque of one of the first and second motors TG1 and TG2 and may also change the front and rear wheel torque distribution ratio while maintaining the total torque by complementarily changing the torque of the first and second motors TG1 and TG2.

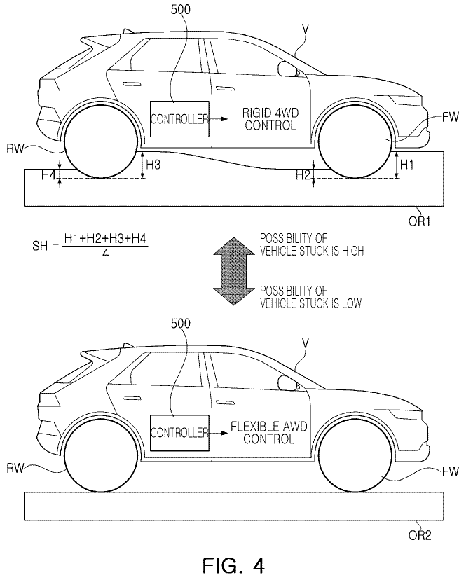

Referring to FIG. 4, the vehicle V may drive on off-road terrains OR1 and OR2. The off-road terrains OR1 and OR2 may include a non-road surface (e.g., a snowy road, a muddy road, a sandy road) and may include a road with a bad road condition. Unlike an ideal road, road surface severity of the off-road terrains OR1 and OR2 may vary. For example, a major factor of road surface severity may include a road surface level deviation SH, and the road surface level deviation SH may be an average of a front level H1 of a front wheel FW, a rear level H2 of the front wheel FW, a front level H3 of a rear wheel RW, and a rear level H4 of the rear wheel RW, and the reference for the levels H1, H2, H3, and H4 may be, but is not limited to, the lowest level of the road surface.

However, the road surface severity may include additional factors (e.g., a change in road surface level deviation according to wheel torque, etc.) in addition to the road surface level deviation SH. For example, snow, mud, and sand may have different particle bonding strengths, so the change in road surface level deviation according to wheel torque may be different in snow terrain, mud terrain, and sand terrain.

As the road surface severity (e.g., a road surface level deviation and/or a road surface level deviation change according to the torque of the wheel) of the off-road terrains OR1 and OR2 is higher, the possibility that a front wheel FW and/or a rear wheel RW of the vehicle V will get stuck at a specific point (e.g., a point at which a level slope is the steepest) of the off-road terrains OR1 and OR2 and cannot get out (i.e., the possibility of vehicle stuck) may increase.

For example, the level deviation SH of the off-road OR1 may be greater than that of the off-road OR2, the road surface severity of the off-road OR1 may be greater than that of the off-road OR2, and the possibility of the vehicle V getting stuck in off-road terrain OR1 may be higher than that of the vehicle V getting stuck in off-road terrain OR2.

The apparatus for supporting off-road driving and the controller 500 of the vehicle V according to an embodiment of the present disclosure may receive the off-road driving data (IN of FIGS. 1 and 2) from the sensor unit (300 of FIGS. 1 and 2) and may be configured to control AWD flexibility according to AWD flexibility control data (OUT of FIGS. 1 and 2) by applying off-road driving data to the AWD flexibility logic. The AWD flexibility logic may be configured to vary the AWD flexibility (e.g., RIGID 4WD, FLEXIBLE AWD) depending on the possibility of the vehicle V getting stuck (e.g., high, low) on the off-road terrains OR1 and OR2 based on the off-road driving data.

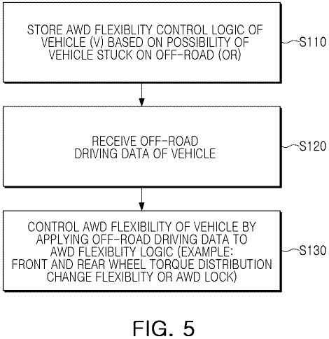

Referring to FIGS. 4 and 5, a method for supporting off-road driving according to an embodiment of the present disclosure may include an operation (S110) in which the controller 500 stores the AWD flexibility logic of the vehicle V based on a possibility of the vehicle V getting stuck in off-road terrain (OR); an operation (S120) in which the controller 500 receives off-road driving data of the vehicle V; and an operation (S130) in which the controller 500 controls AWD flexibility (e.g., flexibility in changing front and rear wheel torque distribution or whether AWD is locked) of the vehicle V by applying the off-road driving data to the AWD flexibility logic.

The AWD flexibility may correspond to the torque change flexibility of the first and second motors TG1 and TG2 according to AWD control or may correspond to the independence between the torque of the first motor TG1 and the torque of the second motor TG2. For example, AWD flexibility may be implemented as a weight (e.g., 0, 0.5, 1) (or intervention level) of output data of the vehicle stability control logic and/or performance-fuel efficiency optimization control logic for AWD control, as a weight of a range of change in front and rear wheel torque distribution according to AWD control, or as an inverse weight of a minimum torque value of the front and rear wheels according to AWD control, but is not limited thereto. A weight of 0 may include deactivation, full-lock, and OFF, a weight of 1 may include activation, full-use, ON, and default, and a weight between 0 and 1 may include partial activation and partial-lock.

As the AWD flexibility is higher, the performance and/or efficiency of the AWD control may be higher, so that the overall optimality of at least one of the performance, fuel efficiency, and stability of the vehicle V may be further improved. As the AWD flexibility is lower, a dynamic change range of the torque of each of the first and second motors TG1 and TG2 may be narrowed, so that the minimum driving power of each of the first and second motors TG1 and TG2 may be stably secured.

For example, since the possibility of the vehicle V getting stuck in off-road terrain OR1 may be high, the controller 500 may stably secure the minimum driving power of each of the first and second motors TG1 and TG2 by reducing the AWD flexibility (e.g., RIGID 4WD control) (including AWD deactivation) in a situation in which the vehicle V has a potential to get stuck and reduce a final possibility of the vehicle V getting stuck.

For example, since the possibility of the vehicle V getting stuck in off-road terrain OR2 may be low, the controller 500 may improve the overall optimality of at least one of the performance, fuel efficiency, and stability of the vehicle V by increasing the AWD flexibility (e.g., FLEXIBLE 4WD control) (including the default AWD control).

Accordingly, the apparatus for supporting off-road driving and the vehicle V according to an embodiment of the present disclosure may efficiently improve the overall optimality of at least one of the performance, fuel efficiency, and stability of the vehicle V, while efficiently reducing the overall final possibility of vehicle stuck on the off-road terrains OR1 and OR2 even if the road surface severity of the off-road terrains OR1 and OR2 varies.

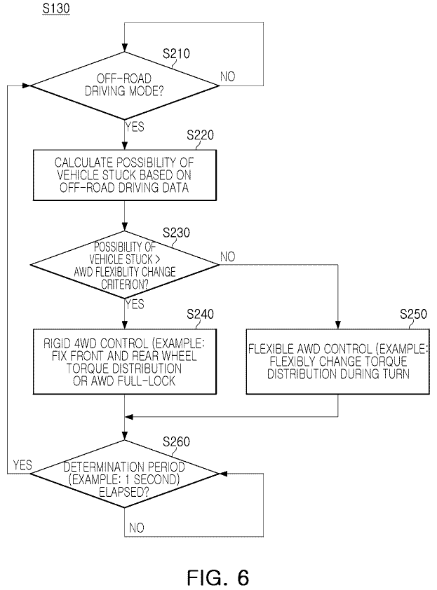

Referring to FIGS. 4 and 6, the AWD flexibility logic may be configured to calculate (S220) the possibility of vehicle stuck (e.g., stuck score data) based on off-road driving data. For example, the AWD flexibility logic may include logic (e.g., equations for the calculation) for calculating the possibility of vehicle stuck (e.g., stuck score data).

For example, in order to increase the accuracy of calculating (or estimating) the possibility of vehicle stuck from off-road driving data, vehicle (prototype) driving experiments on various off-road terrains may be conducted cumulatively. In this process, the controller 500 may gradually optimize (e.g., optimization of coefficients and constants of equations for the calculation) the logic (which may be included in the AWD flexibility logic) for calculating the possibility of vehicle stuck (e.g., stuck score data) from off-road driving data.

For example, the controller 500 may further increase the accuracy of the possibility of vehicle stuck by calculating parameter data between the off-road driving data and the possibility of vehicle stuck. For example, the parameter data may include a slip ratio of the wheel (the front wheel FW and/or the rear wheel RW) and/or a coefficient of friction for off-road. The slip ratio may be defined as a value obtained by dividing a difference between the number of rotations of the wheels (front wheels FW and/or rear wheels RW) and the speed of the vehicle V by the number of rotations or the speed. The coefficient of friction may be defined by a different equation than the slip ratio.

For example, in a situation in which the vehicle V has a potential to become stuck, a road of the wheels (front wheels FW and/or rear wheels RW) may be reduced, and as the road is reduced, the slip ratio may be increased. The slip ratio may also be increased when the coefficient of friction is reduced. As the value obtained by dividing the slip ratio by the coefficient of friction increases, the road surface severity may be increased and the possibility of vehicle stuck may be increased. Therefore, the controller 500 may accurately estimate the possibility of vehicle stuck (e.g., stuck score data) based on at least one of the slip ratio, the coefficient of friction, and the road surface severity.

The AWD flexibility logic may be configured to selectively (YES/NO in S210) control AWD flexibility depending on whether the off-road driving mode is used. The controller 500 may determine whether the off-road driving mode is used, either manually according to input (e.g., a mode setting method through manual input by a driver) or automatically based on the off-road driving data (e.g., a method of setting a mode by automatically determining whether the minimum criterion for road surface severity or possibility of vehicle stuck is reached).

Accordingly, the possibility that other control logic used when the vehicle V is not driving on an off-road conflicts with the AWD flexibility logic may be prevented in advance. For example, the controller 500 may deactivate the off-road driving mode when the vehicle V is driving on a paved road and may activate the off-road driving mode when the vehicle V is driving on an off-road.

The AWD flexibility logic may be configured such that, when the possibility of vehicle stuck is lower than an AWD flexibility change criterion (NO in S230), the controller 500 controls (S250) to a high AWD flexibility (e.g., FLEXIBLE AWD), and when the possibility of vehicle stuck is higher than the AWD flexibility change criterion (YES in S230), the controller 500 controls (S240) to a low AWD flexibility (e.g., RIGID 4WD). That is, the AWD flexibility logic may be configured such that the controller 500 further reduces or eliminates the front and rear wheel torque distribution change range of the vehicle (e.g., fixes the front and rear wheel torque distribution ratio to 50:50) when the possibility of vehicle stuck is higher than the AWD flexibility change criterion (YES in S230) compared to when the possibility of vehicle stuck is lower than the AWD flexibility change criterion (NO in S230).

The AWD flexibility logic may be configured to determine the AWD flexibility periodically (S260) at every predetermined determination period. Accordingly, the AWD flexibility control accuracy/reliability may be further improved. For example, the determination period may be less than 10 seconds (e.g., 1 second), but is not limited thereto. A lower limit (e.g., 0.1 seconds, 0.01 seconds) of the determination period may vary depending on the performance of the controller 500.

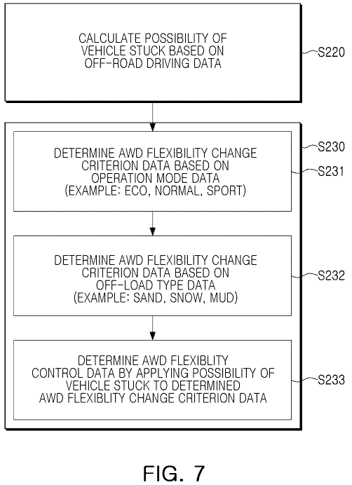

Referring to FIGS. 6 and 7, the AWD flexibility logic may be configured such that the AWD flexibility change criterion is determined (S231) according to the driving mode data of the vehicle. For example, the controller 500 may configure driving mode data for selecting one of a plurality of driving modes (e.g., ECO, NORMAL, SPORT) corresponding to different driving performances of the vehicle (e.g., generate according to a separate control logic, such as a terrain mode or generate through manual input by a driver).

For example, compared to the NORMAL mode and the SPORT mode, the ECO mode may be a mode for further improving the fuel efficiency of the vehicle, so the controller may further increase the overall AWD flexibility by raising the AWD flexibility change criterion and efficiently improve the overall optimality of at least one of the performance, fuel efficiency, and stability of the vehicle.

For example, compared to the NORMAL mode and the ECO mode, the SPORT mode may be a mode for further improving the performance (e.g., driving force, driving feel) of the vehicle, so the controller may further decrease the overall AWD flexibility by lowering the AWD flexibility change criterion, and thus improve the overall driving force.

For example, the NORMAL mode may further improve the fuel efficiency of the vehicle compared to the SPORT mode and further improve the performance (e.g., driving force, driving feel) of the vehicle compared to the ECO mode. Depending on the design, the plurality of driving modes may further include additional modes (e.g., a comfort mode, a custom mode).

Referring to FIGS. 6 and 7, the AWD flexibility logic may be configured to determine (S232) the AWD flexibility change criterion according to the off-road type data (e.g., SAND, SNOW, MUD) of the vehicle V and may be configured to determine (S233) the AWD flexibility according to the off-road type data (e.g., SAND, SNOW, MUD) of the vehicle and the possibility of vehicle stuck. For example, the controller 500 may configure (e.g., generate according to a separate control logic, such as the terrain mode, or generate through manual input by the driver) the off-road type data of the vehicle V before receiving the off-road driving data. Accordingly, the AWD flexibility control accuracy/reliability may be further improved.

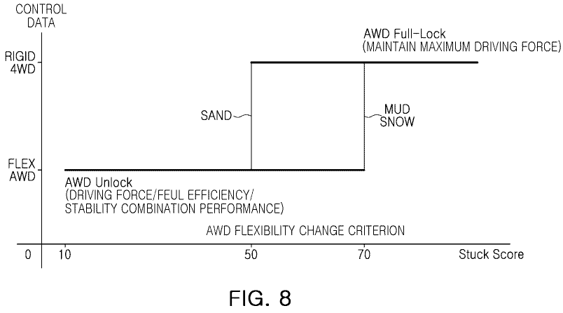

Referring to FIGS. 7 and 8, the off-road type data may include at least two of the snow type data SNOW corresponding to a snowy road, the sand type data SAND corresponding to a sandy road, and the mud type data MUD corresponding to a muddy road. At least two of an AWD flexibility change criterion (e.g., 70) of the snow type data SNOW, an AWD flexibility change criterion (e.g., 70) of the mud type data MUD, and an AWD flexibility change criterion (e.g., 50) of the sand type data SAND may be different from each other, but are not limited thereto.

For example, driving force required to prevent vehicle stuck under the muddy road and/or the snowy road may be less than driving force required to prevent vehicle stuck under the sandy road. Accordingly, the AWD flexibility change criterion (e.g., 70) of the snow type data SNOW and the AWD flexibility change criterion (e.g., 70) of the mud type data MUD may be higher than the AWD flexibility change criterion (e.g., 50) of the sand type data SAND. Accordingly, the AWD flexibility control accuracy/reliability may be further improved.

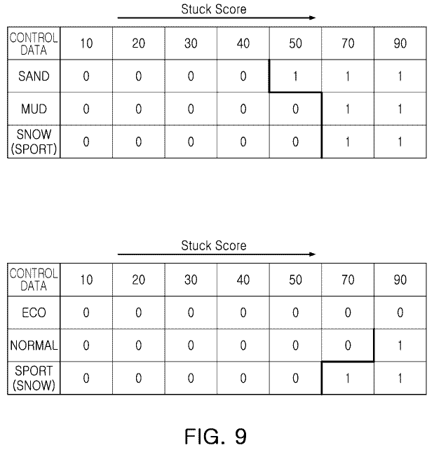

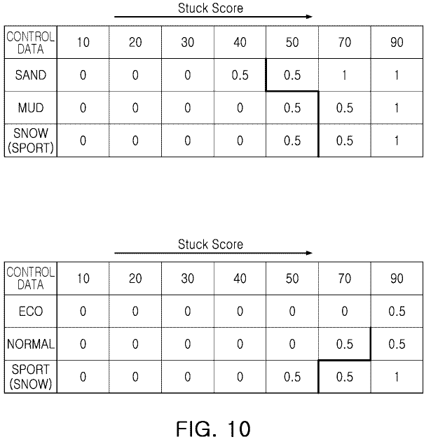

Referring to FIGS. 9 and 10, the controller stores at least one AWD flexibility change criterion set (e.g., two-dimensional data including off-road type data and the possibility of vehicle stuck (stuck score), two-dimensional data including driving mode data and the possibility of vehicle stuck (stuck score), or one-dimensional data including the possibility of vehicle stuck (stuck score)), and the at least one AWD flexibility change criterion set may include an off-road type AWD flexibility change criterion set and/or a driving mode AWD flexibility change criterion set.

For example, 0 of the AWD flexibility control data may correspond to FLEXIBLE AWD control (e.g., default AWD control), 1 of the AWD flexibility control data may correspond to RIGID 4WD control (e.g., AWD Full-Lock control with priority over separate logic, such as the terrain mode), and a boundary line between 0 and 1 of the AWD flexibility control data may correspond to an AWD flexibility change criterion. For example, when a plurality of AWD flexibility change criterion sets are N-dimensional data, the plurality of AWD flexibility change criterion sets may be configured as AWD flexibility change criterion sets of a single (N+1)-dimensional data.

For example, the AWD flexibility logic may be configured to vary the AWD flexibility based on the AWD flexibility change criterion (corresponding to S231 and/or S232 in FIG. 7) determined according to the driving mode data and/or the off-road type data and the possibility of vehicle stuck (corresponding to S233 in FIG. 7). Accordingly, a possibility of confusion occurring between input variables (e.g., the driving mode data, off-road type data, possibility of vehicle stuck) that may be used for AWD flexibility control may be prevented in advance.

Referring to FIG. 10, according to the design, the AWD flexibility change criterion may include a first AWD flexibility change criterion (a boundary line between 0 and 0.5 of the AWD flexibility control data) and a second AWD flexibility change criterion (a boundary line between 0.5 and 1 of the AWD flexibility control data) that is higher than the first AWD flexibility change criterion.

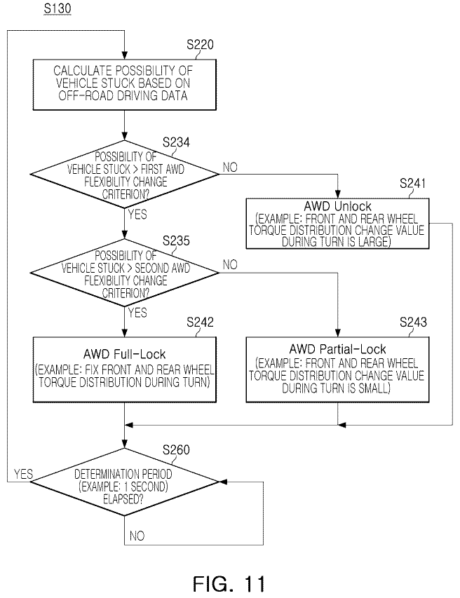

Referring to FIGS. 10 and 11, the AWD flexibility logic may be configured to further reduce or eliminate the front and rear wheel torque distribution change range of the vehicle as the possibility of vehicle stuck (stuck score) increases. 0 of the AWD flexibility control data may correspond to a wide front and rear wheel torque distribution change range of the vehicle (AWD high flexibility) and may correspond to AWD Unlock. 0.5 of the AWD flexibility control data may correspond to a narrow front and rear wheel torque distribution change range of the vehicle (AWD medium flexibility) and may correspond to AWD Partial-Lock. 1 of AWD flexibility control data may correspond to the elimination of the front and rear wheel torque distribution change range of the vehicle (low AWD flexibility) (e.g. fixing the front and rear wheel torque distribution ratio to 50:50) and may correspond to AWD Full-Lock.

The AWD flexibility logic is configured such that, the controller controls (S242) the front and rear wheel torque distribution of the vehicle to be fixed (e.g., AWD Full-Lock) at a predetermined distribution ratio (e.g., 50:50) when the vehicle turns in a case in which the possibility of vehicle stuck is higher than the second AWD flexibility change criterion (YES in S235), controls the AWD in a case in which the possibility of vehicle stuck is lower than the second AWD flexibility change criterion (NO in S235 or NO in S234), and further reduces the front and rear wheel torque distribution change range of the vehicle (e.g., from AWD Unlock to AWD Partial-Lock) in a case in which the possibility of vehicle stuck is higher than the first AWD flexibility change criterion (YES in S234) compared to a case in which the possibility of vehicle stuck is lower than the first AWD flexibility change criterion (NO in S234).

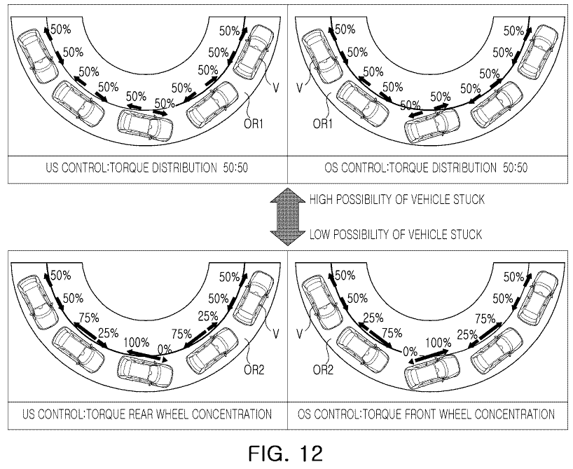

Referring to FIGS. 4 and 12, the controller 500 may reduce the minimum torque values of the front wheels FW and rear wheels RW of the vehicle V when the vehicle V is in a turning state or when the vehicle stability is below a stability reference as the AWD flexibility is higher. According to the design, the controller 500 may concentrate more torque on the front wheels FW when the vehicle V is in an oversteer OS state as the AWD flexibility is higher, and may concentrate more torque on the rear wheels RW when the vehicle V is in an understeer (US) state as the AWD flexibility is higher.

For example, when the possibility of vehicle stuck is low, the controller 500 may reduce the minimum torque value (or front-to-rear wheel torque distribution ratio) of the front wheels FW and rear wheels RW to 0% of the total torque (e.g., 25% in the case of Partial AWD) by increasing the AWD flexibility and flexibly controlling the AWD during a turn. Accordingly, the stability (e.g., anti-slip property) of the vehicle V during a turn may be improved. Depending on the design, the controller 500 may increase the torque (or front-to-rear wheel torque distribution ratio) of the front wheels FW to 100% of the total torque (e.g., 75% in the case of Partial AWD) in an oversteer OS state and may increase the torque (or front-to-rear wheel torque distribution ratio) of the rear wheels RW to 100% of the total torque (e.g., 75% in the case of Partial AWD) in an understeer (US) state.

For example, when the possibility of vehicle stuck is high, the controller 500 may increase the minimum torque value (or front-to-rear torque distribution ratio) of the front wheels FW and rear wheels RW during a turn to 50% of the total torque by lowering the AWD flexibility. Accordingly, the overall driving force of the vehicle V during a turn may be improved, and the possibility of the vehicle V getting stuck during a turn may be reduced. Depending on the design, the controller 500 may fix the torque (or front-to-rear torque distribution ratio) of the front wheels FW and rear wheels RW to 50% of the total torque, regardless of whether the vehicle is in an oversteer OS state or an understeer (US) state.

For example, the controller 500 may determine whether there is an oversteer OS state (a steering angle is greater than a yaw rate) or an understeer (US) state (the steering angle is less than the yaw rate) based on the large/small relationship between a sensing value of the steering angle sensor 307 of the sensor unit 300 and a sensing value of the yaw rate sensor 301.

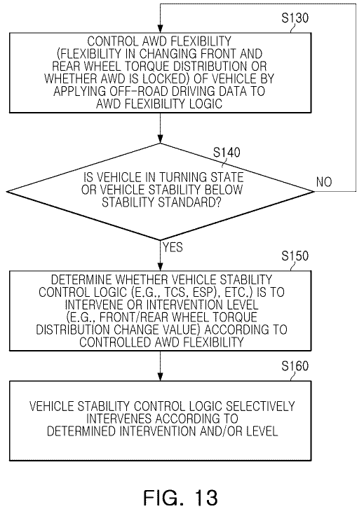

Referring to FIGS. 5 and 13, the method for supporting off-road driving according to an embodiment of the present disclosure may further include an operation (S150) of selectively determining whether the vehicle stability control logic (e.g., turning control logic, traction control system (TCS), electronic stability program (ESP), etc.) is to intervene or to intervene or an intervention level thereof according to AWD flexibility, depending on whether the vehicle is in a turning state or vehicle stability is below a stability reference (S140); and an operation (S160) of generating front wheel torque control data and rear wheel torque control data determined to improve vehicle stability by applying off-road driving data to the vehicle stability control logic when the vehicle stability control logic intervenes. In operation (S150), the controller may determine whether to intervene or the intervention level of the vehicle stability control logic depending on AWD flexibility. In operation (S160), when the vehicle stability control logic is intervened, the controller may generate front wheel torque control data and rear wheel torque control data determined to improve vehicle stability by applying the off-road driving data to the vehicle stability control logic and may output the front wheel torque control data and the rear wheel torque control data to the first and second motors.

For example, when the possibility of vehicle stuck is low, the controller 500 may cause the vehicle stability control logic to intervene in the AWD control at a high intervention level (e.g., a high weight of output data) by increasing the AWD flexibility, thereby flexibly controlling the AWD during a turn. Accordingly, the stability (e.g., anti-slip property) of the vehicle V during a turn may be improved.

For example, when the possibility of vehicle stuck is high, the controller 500 may not cause the vehicle stability control logic to intervene in the AWD control by decreasing the AWD flexibility. Accordingly, the overall driving force of the vehicle V may be improved during a turn, and the possibility of the vehicle V getting stuck during a turn may be reduced.

For example, when the possibility of vehicle stuck is medium, the controller 500 may determine the AWD flexibility as medium to cause the vehicle stability control logic to intervene in the AWD control at a low intervention level (e.g., a low weight of output data).

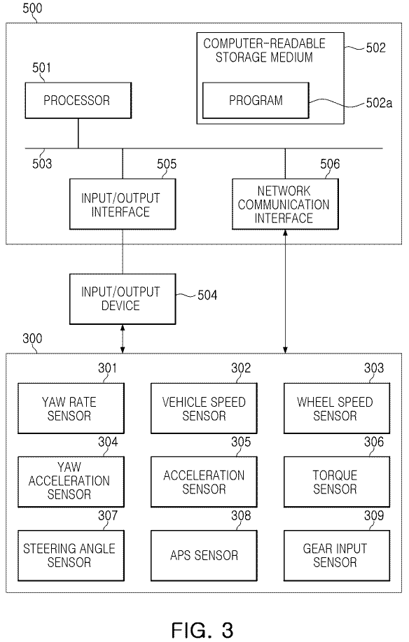

Meanwhile, referring to FIG. 3, the controller 500 may be implemented as a computing system including at least one processor 501, a computer-readable storage medium 502, and a communication bus 503. For example, the controller 500 may be implemented as a microcontroller, an embedded system, a system on chip, etc. The storage medium 502 may record one or more programs including commands for executing a method for supporting off-road driving according to an embodiment of the present disclosure. The communication bus 503 may interconnect various other components of the computing device 500, including the processor 501 and the computer-readable storage medium 502.

The processor 501 may cause the controller 500 to operate according to the embodiments described above. For example, the processor 501 may execute one or more programs stored on the computer-readable storage medium 502. The one or more programs may include one or more computer-executable instructions, which, when executed by the processor 501, may be configured to cause the controller 500 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, or any other form of storage medium that may be accessed by the controller 500 and capable of storing desired information, or a suitable combination thereof.

The controller 500 may also include one or more input/output interfaces 505 providing an interface for one or more input/output devices 504 and one or more network communication interfaces 506. The input/output interfaces 505 and the network communication interfaces 506 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth®, Near Field Communication (NFC), Zigbee®, Radio Frequency (RF), etc.

The input/output device 504 may be connected to other components of the controller 500 via the input/output interface 505. The input/output devices 504 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 504 may be included inside the controller 500 as a component including the controller 500 or may be connected to the controller 500 as a separate device distinct from the controller 500.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The apparatus and method for supporting off-road driving and the vehicle and storage medium including the same according to an embodiment of the present disclosure may efficiently improve the overall optimality of at least one of the performance, fuel efficiency, and/or stability of the vehicle, while efficiently reducing the overall final possibility of vehicle stuck in off-road terrain even when the road surface severity of the off-road varies.

For example, when the road surface severity of the off-road is low, the stability (e.g., anti-slip property) of the vehicle during a turn may be improved by AWD control. For example, when the road surface severity of the off-road is high, the possibility of vehicle stuck during a turn may be reduced.

While embodiments have been shown and described above, it will be apparent to those skilled in the art that modifications and variations could be made without departing from the scope of the present disclosure as defined by the appended claims.

What is claimed is:

1. An apparatus for supporting an off-road driving, the apparatus comprising:
a controller configured to receive off-road driving data of a vehicle capable of all-wheel drive (AWD) and control AWD flexibility of the vehicle according to AWD flexibility control data by applying the off-road driving data to AWD flexibility logic,
wherein the AWD flexibility logic is configured to vary the AWD flexibility according to a possibility of vehicle stuck in off-road terrain based on the off-road driving data.

2. The apparatus of claim 1, wherein the AWD flexibility logic is configured such that the controller further reduces or eliminates a front and rear wheel torque distribution change range of the vehicle when the possibility of vehicle stuck is higher than an AWD flexibility change criterion, compared to when the possibility of vehicle stuck is lower than the AWD flexibility change criterion.

3. The apparatus of claim 2, wherein
the AWD flexibility change criterion includes a first AWD flexibility change criterion and a second AWD flexibility change criterion higher than the first AWD flexibility change criterion, and
the AWD flexibility logic is configured such that, when the possibility of vehicle stuck is higher than the second AWD flexibility change criterion, the controller fixes the front and rear wheel torque distribution of the vehicle to a predetermined distribution ratio, and when the possibility of vehicle stuck is higher than the first AWD flexibility change criterion, compared to when the possibility of vehicle stuck is lower than the first AWD flexibility change criterion, the controller further reduces the front and rear wheel torque distribution change range of the vehicle.

4. The apparatus of claim 2, wherein the controller reduces a minimum torque value of front and rear wheels of the vehicle based on that the vehicle is in a turning state or the vehicle stability is below a stability reference, as the AWD flexibility is higher.

5. The apparatus of claim 4, wherein the controller concentrates more torque on the front wheel based on that the vehicle is in an oversteer state, as the AWD flexibility is higher, and
the controller concentrates more torque on the rear wheel based on that the vehicle is in an understeer state, as the AWD flexibility is higher.

6. The apparatus of claim 2, wherein
the controller configures off-road type data of the vehicle,
the off-road type data includes at least two of snow type data corresponding to a snowy road, sand type data corresponding to a sandy road, or mud type data corresponding to a muddy road, and
the AWD flexibility logic is configured to determine the AWD flexibility change criterion according to the off-road type data of the vehicle.

7. The apparatus of claim 2, wherein
the controller configures driving mode data for selecting one of a plurality of driving modes corresponding to different driving performances of the vehicle, and
the AWD flexibility logic is configured such that the AWD flexibility change criterion is determined according to the driving mode data of the vehicle.

8. The apparatus of claim 1, wherein
the controller determines whether a vehicle stability control logic is to intervene according to the AWD flexibility, and
when the vehicle stability control logic intervenes, the controller generates front wheel torque control data and rear wheel torque control data determined to improve vehicle stability by applying the off-road driving data to the vehicle stability control logic.

9. The apparatus of claim 1, wherein
the controller receives the off-road driving data from a sensor unit, and
the off-road driving data includes at least one of a speed of the vehicle, acceleration of the vehicle, a yaw rate of the vehicle, a yaw acceleration of the vehicle, a steering angle of the vehicle, a number of rotations of a wheel of the vehicle, a torque of the vehicle, or an acceleration input value of the vehicle.

10. The apparatus of claim 9, wherein the AWD flexibility logic is configured to periodically determine the AWD flexibility at every predetermined determination period, and
the determination period is less than 10 seconds.

11. The apparatus of claim 9, wherein
the AWD flexibility logic is configured to selectively control the AWD flexibility depending on whether the off-road driving mode is used, and
the controller determines whether to use the off-road driving mode, either manually according to an input or automatically based on the off-road driving data.

12. A method for supporting off-road driving, the method comprising:
storing AWD flexibility logic of a vehicle based on a possibility of vehicle stuck of a vehicle capable of all-wheel drive (AWD) on an off-road;
receiving off-road driving data of the vehicle; and
controlling AWD flexibility of the vehicle by applying the off-road driving data to the AWD flexibility logic.

13. The method of claim 12, wherein the AWD flexibility logic is configured to further reduce or eliminate a front and rear wheel torque distribution change range of the vehicle as the possibility of vehicle stuck increases.

14. The method of claim 12, wherein
the AWD flexibility logic is configured to determine the AWD flexibility according to off-road type data of the vehicle and the possibility of vehicle stuck, and
the off-road type data includes at least two of snow type data corresponding to a snowy road, sand type data corresponding to a sandy road, or mud type data corresponding to a muddy road.

15. The method of claim 12, further comprising:
selectively determining whether the vehicle stability control logic is to intervene or an intervention level of the vehicle stability control logic according to the AWD flexibility, depending on whether the vehicle is in a turning state or vehicle stability is below a stability reference; and
generating front wheel torque control data and rear wheel torque control data determined to improve vehicle stability by applying the off-road driving data to the vehicle stability control logic when the vehicle stability control logic intervenes.

16. A non-transitory storage medium having recorded thereon one or more programs including instructions for executing the method for supporting off-road driving of claim 12.

17. A vehicle comprising:
a controller including a processor and a non-transitory storage medium having recorded thereon one or more programs configured to be executable by the processor,
wherein the one or more programs include instructions for executing the method for supporting off-road driving of claim 12.

18. A vehicle comprising:
a first motor providing torque to a front wheel;
a second motor providing torque to a rear wheel;
a sensor unit sensing off-road driving data; and
a controller configured to control the first motor and the second motor to enable all-wheel drive (AWD) and control AWD flexibility according to AWD flexibility control data by applying the off-road driving data to an AWD flexibility logic,
wherein the AWD flexibility logic is configured to vary the AWD flexibility according to the possibility of the vehicle stuck in off-road terrain based on the off-road driving data.

19. The vehicle of claim 18, wherein
the AWD flexibility logic is configured such that the controller further reduces or eliminates a front and rear wheel torque distribution change range of the vehicle when the possibility of vehicle stuck is higher than an AWD flexibility change criterion, compared to when the possibility of vehicle stuck is lower than the AWD flexibility change criterion,
the AWD flexibility logic is configured such that the AWD flexibility change criterion is determined according to off-road type data, and
the off-road type data includes at least two of snow type data corresponding to a snowy road, sand type data corresponding to a sandy road, or mud type data corresponding to a muddy road.

20. The vehicle of claim 18, wherein the controller reduces a minimum torque value of the front and rear wheels when the vehicle is in a turning state or vehicle stability is below a stability reference as the AWD flexibility increases.
